(19) United States
(12) Patent Application Publication
(10) Pub. No.: US 2016/0082939 A1
(43) Pub. Date: Mar. 24, 2016

(54) PARK BRAKE CONTROL ASSEMBLY

(71) Applicant: FAIVELEY TRANSPORT AUSTRALIA LTD, Sydney (AU)

(72) Inventor: Andrew Cole, Sydney (AU)

(21) Appl. No.: 14/405,712

(22) PCT Filed: Jun. 6, 2013
(86) PCT No.: PCT/AU13/00602

§ 371 Date: Dec. 4, 2014

(30) Foreign Application Priority Data
Jun. 7, 2012 (AU) 2013902382
Apr. 14, 2013 (AU) 2013205185

(51) Int. Cl. B60T 13/66; B60T 15/18; B60T 15/02

(52) U.S. Cl. CPC B60T 13/665; B60T 15/021; B60T 15/184

(57) ABSTRACT

A park brake control assembly (10) for a rail vehicle having a brake pipe (20), a distributor (30), an air supply reservoir (40), one or more brake cylinders (50) and one or more pneumatically operated park brakes (60), the distributor (30) and the park brake control assembly (10) each having an output port (35, 15), wherein the park brake control assembly (10) includes a plurality of valves (11, 12) responsive to one or more of the following: (a) brake pipe air pressure; (b) air pressure in the output port (35) of the distributor (30); (c) air pressure in the output port (15) of the assembly (10).

### FIELD OF THE INVENTION

This invention broadly relates to the control of park brakes on rail vehicles, especially suitable for use on freight wagons.

### BACKGROUND OF THE INVENTION

Park brakes on passenger cars and freight wagons in trains are used in a variety of ways. They may be used to prevent the vehicles from rolling away when unpowered or not connected to a locomotive. They may also be used for securing vehicles or trains at a railyard or where trains are required to be stopped en route.

Park brakes may be used in other circumstances, for example when vehicles need to be decoupled for inspection or repair purposes, and they need to be individually secured; this becomes even more relevant where a train must be stopped at a location where the track has a gradient, as the vehicles may develop their own momentum and move due to gravity.

In the past, vehicles have been supplied with mechanical park brakes that are manually operated. Manually operated park brakes are inconvenient, and are a cause for safety concerns. Automatic park brakes may take several forms which include, but are not limited to, spring park brakes and park lock types where for instance the service brake cylinder is locked by a mechanical device. Automatic park brakes can alleviate safety concerns when a train must be secured in an environment with poor visibility or restricted access such as a tunnel or bridge to avoid exposure of rail personnel.

Automatic park brakes, in particular, offer significant advantages because the vehicles can be secured in a timely fashion. Rather than requiring the manual application of park brakes at each individual vehicle, the park brakes can be applied and released from the front of the train. This is valuable where trains are long.

Pneumatically operated park brakes have the benefit of not relying on a source of electrical power and wiring in order to function. As park brakes are an important safety feature, pneumatically operated park brakes are preferred for both pneumatically and electropneumatic (ECP) controlled brake systems.

It will further be understood that a pneumatic park brake that applies or releases according to brake pipe pressure only can be unsuitable. In this arrangement, the park brake applies when the brake pipe pressure drops (possibly, below a pre-determined value), and releases when the brake pipe pressure rises (possibly, above a pre-determined value). This type of park brake control is not suited to maintaining the application of the park brake where the brake pipe pressure must be raised to fully charge the system and release the pneumatic brake application.

Also, this form of control would preclude the possibility of undertaking any form of operational test to confirm that park brakes are applied. Such a test would typically involve releasing the pneumatic brakes and applying a designated amount of traction power from the locomotive to confirm that there is a sufficient level of resistance to motion, thus confirming that park brakes are applied. For this form of park brake control, the raising of brake pipe pressure to achieve release of pneumatic brakes would also release the park brakes and thus this form of test would not be possible.

When a train is stopped and remains stationary for some time, for example due to a break down, track disturbance or some other safety concern, brake pipe and brake cylinder pressure may leak off, potentially allowing a roll away. Operating rules typically require that park brakes are applied in such circumstances.

Similarly, it is desirable for the train driver to be able to charge the brake pipe and each vehicle's reservoirs while maintaining the train in a parked condition. Once the train driver decides that the train is in a condition to start moving, it is desirable that the park brakes can be released in a coordinated manner so as to minimise the risk of wagon brakes being dragged anywhere along the train.

It would therefore be desirable if a train driver were able, most conveniently from inside the head end unit, to do each of the following after stopping a train: (a) keep each vehicle secure for as long as required; (b) fully recharge the brake pipe and reservoirs whilst keeping each vehicle secure; and (c) coordinate the release of the train's park brakes when the train is ready to set off.

### SUMMARY OF THE INVENTION

Accordingly, this invention provides a park brake control assembly for a rail vehicle having a brake pipe, a distributor, an air supply reservoir, one or more brake cylinders and one or more pneumatically operated park brakes, the distributor and the park brake control assembly each having an output port, the park brake control assembly including a plurality of valves including a first valve being responsive to brake pipe air pressure and a second valve responsive to either or both:
(a) air pressure in the output port of the distributor;
(b) air pressure in the output port of the assembly.

The rail vehicle may be a passenger vehicle or freight wagon, but is not limited to these types of vehicles.

The distributor may be pneumatically controlled, or electronically controlled as is the case in ECP type systems.

The air supply reservoir may be charged through the brake pipe or through a second pipe.

The brake cylinder is generally a dual chamber cylinder, having a first chamber which is associated with service and emergency braking and a second chamber associated with the park brake. The brake cylinder generally has a piston which responds to the air pressure in the first chamber, and to the park brake energy source (typically one or more springs) associated with the second chamber. Connected to the piston, via mechanical linkages, is a brake shoe (or brake pad) which is used to apply pressure to a wheel (or brake disc connected to a wheel or axle) of the vehicle. The brake cylinder, however, is not intended to be limited to these arrangements.

The park brake is preferably a spring biased brake which has a default ‘apply’ position, that is, it remains applied until the air pressure in the second brake cylinder chamber is sufficient to overcome the resistance provided by the park brake spring. Other forms of park brake are also contemplated.

Preferably, the second valve of the park brake control assembly is responsive to the air pressure in the output port of the distributor to release the park brake, the first valve of the park brake control assembly being responsive to the air pressure in the brake pipe to release the park brake. It is also preferred that at least one of the valves of the park brake control assembly is responsive to the air pressure in the output port of the park brake control assembly to retain (or maintain) the release of the park brake.

In a particularly preferred embodiment, the park brake control assembly has a first valve with one input that is responsive to brake pipe pressure and a second valve with two inputs which are responsive to air pressure in the output port of the distributor and the output port of the assembly, respectively.

In a preferred embodiment, the plurality of valves of the park brake control assembly operates in parallel to apply the brake.

In another preferred embodiment, the plurality of valves acts in series to release the brake. Alternatively, the plurality of valves may operate in another combination to release the brake.

Preferably the park brake control assembly has two valves, each being a bi-state valve and each having a venting port. Alternatively, the park brake control assembly may have more than two valves, some valves may have more than two states and some may not have venting ports.

It is preferred that at least some of the valves are spring biased to respond to a pre-determined air pressure input. The valves may, in certain embodiments, have other means to respond to air pressure input such as electrically controlled solenoid valves. It is preferred that there is pneumatic-only control, and that any electrical valves are auxiliary devices.

Preferably, the park brake control assembly includes an anti-compound valve which does not allow the park brake chamber of the brake cylinder to receive pressure from the distributor and the park brake control assembly at the same time.

Preferably, the park brake control assembly responds to an isolation cock which is able to isolate the park brake control assembly from the park brake chamber of the brake cylinder. Other isolation means, instead of an isolation cock, may be used. In some embodiments, the assembly will include an isolation means, in other embodiments, the assembly may respond to an isolation means separately located on the rail vehicle.

It is preferred that the park brake control assembly, when isolated, will apply the park brake fully.

The park brake control assembly may be combined with the park brake, for example, for body-mounted brake cylinders.

Preferably, the park brake control assembly is able to be used with Faiveley's BFCBF actuators, but the invention is not restricted to this use.

In a preferred embodiment, the park brake control assembly includes a pipe bracket or manifold designed to connect to the air piping of an existing vehicle.

It is preferred that the park brake assembly is compatible with AAR (Association of American Railroads) protocols, but the invention is not limited to these protocols.

### BRIEF DESCRIPTION OF THE DRAWINGS

Possible and preferred features of the present invention will now be described with particular reference to the accompanying drawings. However, it is to be understood that the features illustrated in and described with reference to the drawings are not to be construed as limiting on the scope of the invention. In the drawings:

FIG. 1 shows schematically an embodiment of a park brake control assembly according to the present invention, in a first mode of operation, namely system charging;

FIG. 2 shows schematically the embodiment of FIG. 1, in a second mode of operation, namely system charging—park brake application;

FIG. 3 shows schematically the embodiment of FIG. 1, in a third mode of operation, namely a first service brake application—park brake release;

FIG. 4 shows schematically the embodiment of FIG. 1, in a fourth mode of operation, namely park brake application;

FIG. 5 shows schematically the embodiment of FIG. 1, in a fifth mode of operation, release of service/emergency brake—continued park brake application; and

FIG. 6 shows schematically the embodiment of FIG. 1, in a sixth mode of operation, isolation of park brake control assembly.

### DETAILED DESCRIPTION OF THE DRAWINGS

Before describing the park brake control assembly of the invention in more detail, it is helpful to first describe the typical environment in which the park brake control assembly may be used.

In brake systems for trains, braking signals may be sent down the length of the train to instruct the vehicles to apply and release the brakes as required. Signals may be pneumatically communicated by a brake pipe, which itself travels the length of the train, or the signal may be electrically communicated.

Commonly, each vehicle has an air supply for braking. For the service brake system this air supply comes from a local reservoir (auxiliary reservoir or supplementary reservoir) fed either by the brake pipe, or by air directly fed from a second pipe. For the pipe or pipes running the length of the train, their continuity between the vehicles is provided by hoses.

For the park brake system, the air may be supplied either by local reservoirs or directly, through either the brake pipe or by a second pipe, if present.

Service braking is normally controlled by a distributor (control valve), located on each vehicle or on one vehicle of a master/slave pair of vehicles. The output pressure of the distributor is connected to one (or more) brake cylinder(s) of the rail vehicle. The distributor may be controlled either pneumatically or electronically (eg. ECP type systems).

Generally, for a system with pneumatically operated park brakes, some or all of the brake cylinders may incorporate the park brake. In the case of a brake cylinder which has a park brake, the brake cylinder may have dual chambers. The first chamber is the service/emergency brake chamber. When it fills with air, a piston is moved which in turn applies pressure via mechanical linkages to one or more brake shoes acting on one or more wheels of the vehicle (or, for disc brakes, to brake pads acting on a brake disc which is mechanically connected to the wheel or axle of the vehicle). For example, there may be a single cylinder for each wheel, or one or two cylinders acting on four blocks/wheels, or a single cylinder acting on four blocks/wheels, or one cylinder for eight wheels.

The second chamber is the park brake chamber in which same piston is acted upon indirectly. However, unlike the service/emergency brake, the park brake is by default in the apply position and is only released when the air pressure in the park brake chamber can overcome the resistance of a spring located therein.

Alternatively, separate park brake and service brake cylinders can be utilised.

The following is a description of an embodiment of the assembly as applied to freight wagons; however the invention is not limited to such applications.

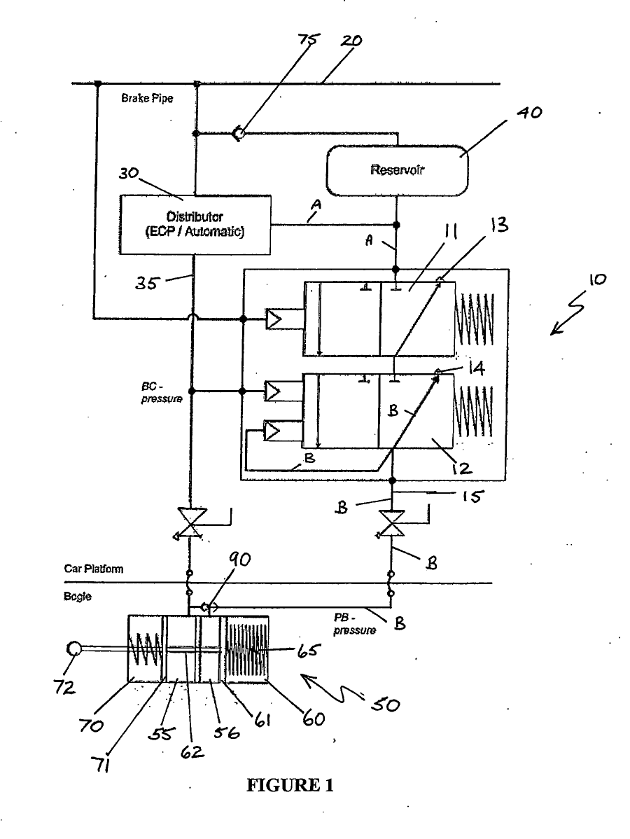

FIGS. 1 to 6 show a park brake control assembly, indicated generally at 10, for a rail vehicle (not shown) having a brake pipe 20, a distributor 30, an air supply being a reservoir 40, and a brake cylinder 50, in which are included a service brake 70 and a park brake 60.

In this embodiment there is a single brake pipe 20 for providing the air supply for reservoir 40 and for conveying pneumatic braking signals using a pneumatic distributor 30. As shown in FIGS. 1-6, the reservoir 40 is fed by the brake pipe 20, with a check valve 75 ensuring air flows only in the direction of the reservoir 40. The reservoir 40 supplies the air used in service/emergency braking as well as that used for controlling the park brake 60. It should be appreciated that the invention is not limited to this application, and may apply to two-pipe systems as well as ECP systems and to systems where the park brake is supplied with air either from a separate reservoir or directly from the brake pipe or a second pipe (if present).

The distributor 30 and the park brake control assembly 10 each has an output port 35 and 15 respectively.

In this preferred embodiment, the brake cylinder 50 has two chambers 55 & 56.

With no air pressure in chambers 55 and 56, the spring 65 applies force via park brake piston 61 and spindle 62 to the top surface of service brake piston 71, causing force to be applied to the brake mechanism via pushrod 72 (park brake is applied).

The output 35 of the distributor 30 may supply air to both the service/emergency brake chamber 55 and park brake chamber 56 of the brake cylinder 50, but the output 15 of the park brake control assembly 10 can only supply air to the park brake chamber 56 of the brake cylinder 50. By the use of an anti-compound valve 90, the larger of the air pressures from the output of the park brake control assembly 15 and the output of the distributor 35 is directed into the park brake chamber 56 of the brake cylinder 50.

The air pressure in service brake chamber 55 acts on service brake piston 71, causing force to be applied to the brake mechanism via pushrod 72 (service brake is applied). The air pressure in park brake chamber 56 acts on park brake piston 61 in opposition to the force of spring 65, reducing or overcoming the force acting via spindle 62 onto the top surface of service brake piston 71. If the pressure in chamber 56 is higher than a pre-determined pressure (park brake release pressure) then there will be no force acting via spindle 62 on piston 71, and the park brake is released.

The park brake control assembly 10 has two spring biased pneumatic valves 11 & 12 which operate to supply air to the park brake chamber 56 of the brake cylinder 50 in series, and to vent air from the park brake chamber 56 in parallel via venting ports 13 & 14 on each valve 11 & 12, respectively.

The first spring biased valve 11 is responsive to pressure in brake pipe 20. The second spring biased valve 12 is responsive to pressure in the output port 35 of the distributor 30, as well as to pressure in the output port 15 of the park brake control assembly 10.

The first and second valves 11 & 12 are bi-state valves which operate in the following way: in a first state (open) they each permit air to flow from the reservoir 40 to the park brake chamber 56 of the brake cylinder 50, and in a second state (closed) they each vent air from the park brake chamber 56 of the brake cylinder 50. The two bi-state valves 11 & 12 operate together in series in order to supply air from the reservoir 40 to the park brake chamber 56: they must each be in their first (open) state at the same time to achieve this result. They also operate in parallel to vent air from the park brake chamber 56 as air is vented if either or both of the valves 11 & 12 are in their second (closed) state. Both of these valves are normally in their second (closed) state in the absence of any control input signals. Therefore, there is a fail-safe aspect of the invention—when the normally closed state the system is vented and the park brake is applied.

Preferably, the valves 11 & 12 in the park brake control assembly 10 are set to change state at pre-determined air pressures (in this embodiment, both valves are set to 200 kilopascals or kPa). It is to be understood that valves 11 and 12 need not both be set at the same pressure.

The preferred embodiment of the invention is now described in relation to six modes of operation, illustrated in FIGS. 1-6.

i) System Charging (Refer to FIG. 1)

Once vehicles are connected to a locomotive (not shown), air is provided along the brake pipe 20 to charge the reservoir 40 on each vehicle. A check valve 75 makes sure that air from the reservoir 40 does not feed back into the brake pipe 20. The reservoir 40 is available to provide air in service braking, via the distributor 30, as well in park brake applications, via the park brake control assembly 10 (lines A). While the reservoir 40 is filling, no service brake is applied and no air is available to release the park brake 60. In this mode, the park brake control assembly 10 is connected to atmosphere via the two valves 11 & 12 and the park brake 60 is applied (lines B).

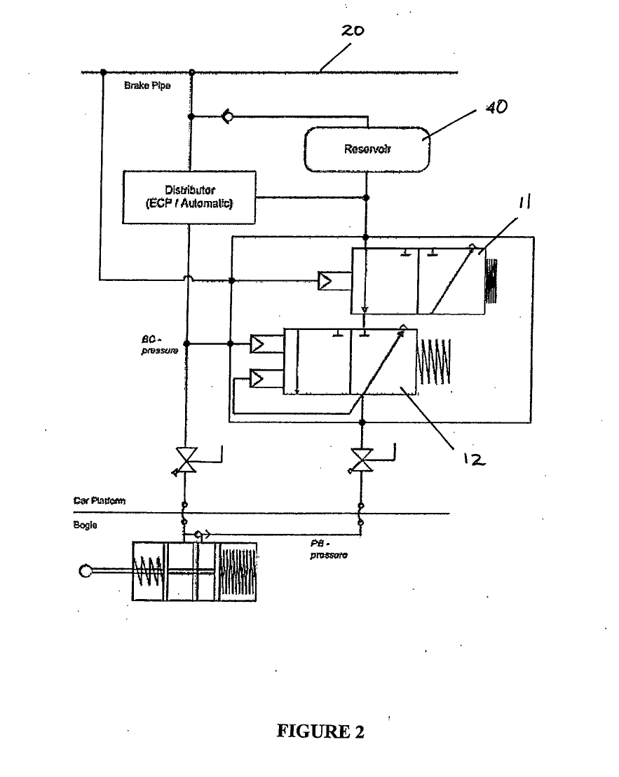

ii) System Charging, Park Brake Application (Refer Principally to FIG. 2)

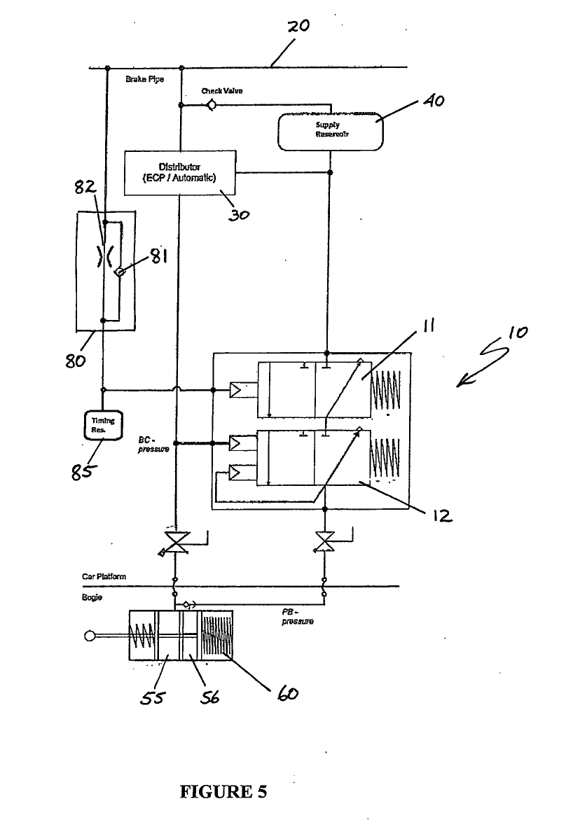

As pressure in the brake system increases, it starts to fill a timing reservoir 85 (see FIG. 5) through the check valve/choke 80. As air cannot pass through the check valve 81 in the opposite direction, the rate of pressure increase in the timing reservoir 85 is determined by the size of the choke 82 and the volume of the timing reservoir 85, and so the pressure in the timing reservoir 85 will rise at a slower rate than pressure in the brake pipe 20 when the system is charging. When the pressure in the timing reservoir 85 is higher than 200 kPa (in this embodiment), the first valve 11 of the park brake control assembly opens and allows the pressure in the reservoir 40 to reach the second valve 12, which remains closed. The wagon is still in charging mode and the park brake 60 is still applied.

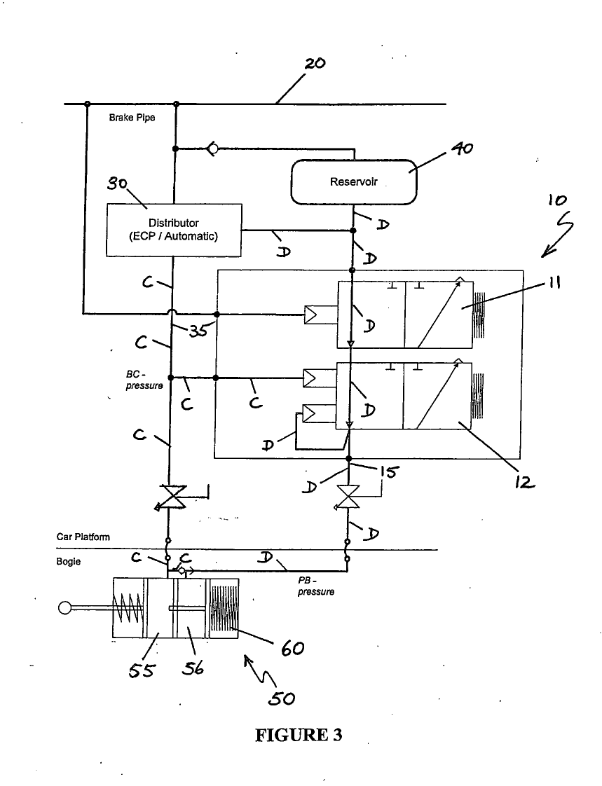

iii) First Service Brake Application—Park Brake Release (Refer to FIG. 3)

Once the wagons are fully charged, the driver will be ready to apply the service brake, allowing the driver to release the park brake 60. Upon initiating the service brake, by reducing the pressure in brake pipe 20, the first and second valves 11 & 12 in the park brake control assembly 10 will release the park brake 60 because the distributor 30 will, in response to the brake pipe pressure reduction, send an output pressure to the service brake chamber 55 within the brake cylinder 50 (lines C). This brake cylinder pressure will also be a control signal to the second valve 12 of the park brake control assembly 10, to allow pressure from the reservoir 40 to reach the park brake chamber 56. As long as there is a pressure higher than 200 kPa in the reservoir 40, the same pressure will keep the valve 12 open and make sure that the park brake 60 is released (lines D). In an automatic distributor setup, the brake pipe pressure does not go below 200 kPa unless an emergency brake request occurs. This means that the first valve 11 of the park brake control assembly 10, responsive to the brake pipe 20, will remain open and so will not cause a ventilation of the park brake chamber 56 and have a park brake 60 application as a result. The driver can then operate the controls to recharge brake pipe 20. This will result in distributor 30 releasing the service brake application, and the pressure at output port 35 will reduce to 0 kPa. The pressure acting on valve 12 from output port 35 will also reduce to 0, however the pressure from the park brake control assembly 10 at output port 15 will maintain valve 12 in its open state, so the pressure in park brake chamber 56 will not be exhausted and park brake 60 will remain in the release state.

Subsequent service brake application and release operations can be made by the driver and the park brake 60 will remain in the release state due to valve 12 being retained in the open position as described above.

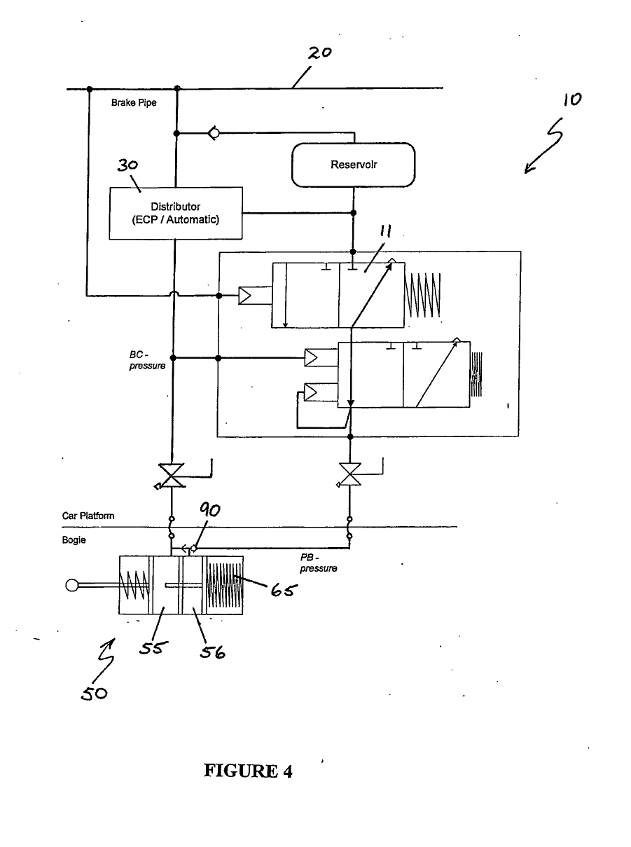

iv) Park Brake Application (Refer to FIG. 4)

An application of the park brake control assembly 10 is done by ventilating the brake pipe 20 to zero (by the driver or wagon break-away). As the brake pipe 20 pressure reduces, it exhausts the timing reservoir 85 (FIG. 5) through the check valve/choke 80. As air can pass freely through the check valve 81 in this direction, the pressure in the timing reservoir 85 will fall at a similar rate to the pressure in the brake pipe 20. This means that the first valve 11, controlled by the brake pipe/timing reservoir 85 pressure, will close and ventilate the park brake chamber 56. However, at the same time the reduction in brake pipe pressure will cause an emergency brake request from the distributor 30, which will send a service (or emergency) brake pressure to the service/emergency brake chamber 55 of brake cylinder 50. The brake cylinder 50 will be equipped with an anti-compound valve 90 not allowing the brake cylinder 50 to have both service and park brake pressure applied at the same time. The same pressure in the service/emergency brake chamber 55 will be sent into the park brake chamber 56 and compress the park brake spring 65 accordingly. If the wagon is left in this state, once the air has been exhausted or has leaked out from the service/emergency brake chamber 55 (and the park brake chamber 56), the park brake 60 will apply completely.

v) Release of Emergency Brake—Continued Park Brake Application (Refer to FIG. 5)

After exhausting the brake pipe 20 to zero, the train driver can now release the emergency brake application by recharging the brake pipe 20. As the brake pipe pressure increases, it starts to fill the timing reservoir 85 through the check valve/choke 80. As air cannot pass through the check valve 81 in the opposite direction, the rate of pressure increase in the timing reservoir 85 is determined by the size of the choke 82 and the volume of reservoir 85, and so the pressure in the timing reservoir 85 will rise at a slower rate than brake pipe 20 pressure when the system is charging. When the pressure in the timing reservoir 85 is higher than 200 kPa, the first valve 11 opens and allows pressure from the reservoir 40 to reach the second valve 12. By this time, the brake pipe 20 pressure will have risen sufficiently to cause the distributor 30 to release the service/emergency brake application, and service/emergency brake chamber 55 pressure will have reduced below 200 kPa, allowing the second valve 12 to close; therefore air from reservoir 40 cannot reach the park brake chamber 56 and the park brake 60 remains applied.

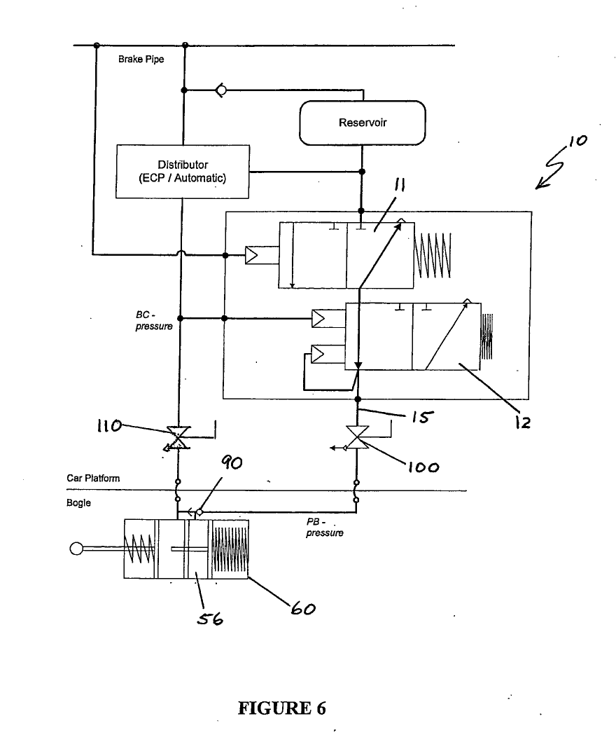

vi) Isolation of Park Brake Control Assembly (Refer to FIG. 6)

If an isolation of a park brake 60 is necessary, an isolation cock 100 is closed to isolate the park brake chamber 56 from the park brake control assembly 10. The same isolation cock 100 will ventilate the downstream side of the park brake chamber 56 and apply the park brake 60 fully. Air may be present between output port 15 and isolation cock 100, depending on the state of inputs to valves 11 and 12, but this will have no effect if isolation valve 100 is closed.

Once the isolation cock 100 has been applied, manual release of the park brake needs to be effected to release the spring force inside the park brake 60, which then enables an operator to move the wagon without the spring park brake applied. To reset the function, the isolation cock 100 needs to be opened and the park brake chamber 56 charged (by making a service brake application) to make the park brake 60 ready for park brake functionality again.

If a wagon is required to be operated in service with the park brake 60 isolated, then the service brake will also need to be isolated on that wagon by closing isolation cock 110, so that the park brake 60 mechanism is not reset by a service brake application via the anti-compound valve 90.

It will be appreciated by a person skilled in the art that the park brake control assembly of the invention is designed to keep the park brake of a wagon applied after the driver signals a release from emergency braking and then wishes to recharge the brake pipe. Thus the train driver is able to charge the brake pipe and each vehicle's reservoirs while maintaining the train in a parked condition.

The park brake control assembly can also require a service brake application to trigger the park brake release.

It will be appreciated by those skilled in the art that many modifications and variations may be made to the embodiments described herein without departing from the spirit or scope of the invention.

### INDUSTRIAL APPLICABILITY

The park brake control assembly is industrially applicable in that it allows a train driver to keep the park brake of a wagon applied after signalling a release from emergency braking, and to charge the brake pipe and each vehicle's reservoirs while maintaining the train in a parked condition.

1. A park brake control assembly for a rail vehicle having a brake pipe, a distributor, an air supply reservoir, one or more brake cylinders and one or more pneumatically operated park brakes, the distributor and the park brake control assembly each having an output port, the park brake control assembly including a plurality of valves including a first valve being responsive to brake pipe air pressure and a second valve responsive to either or both:
(a) air pressure in the output port of the distributor;
(b) air pressure in the output port of the assembly.

2. The park brake control assembly according to claim 1, wherein the plurality of valves of the park brake control assembly operates in parallel to apply the brake.

3. The park brake control assembly according to claim 1, wherein the plurality of valves of the park brake control assembly operates in series to release the brake.

4. The park brake control assembly according to claim 1, wherein the plurality of valves operates in combination to release the brake.

5. The park brake control assembly according to claim 1, wherein each of the first and second valves of the park brake control assembly has a venting port.

6. The park brake control assembly according to claim 1, wherein at least one of the valves of the park brake control assembly is spring biased to respond to a pre-determined air pressure input.

7. The park brake control assembly according to claim 1, wherein the brake cylinder is a dual chamber cylinder, having a first chamber which is associated with service and emergency braking and a second chamber associated with the park brake.

8. The park brake control assembly according to claim 7, wherein the park brake control assembly includes an anti-compound valve for preventing the second chamber of the brake cylinder to receive pressure from the distributor and the park brake control assembly at the same time.

9. The park brake control assembly according to claim 7, wherein the park brake control assembly is a spring biased brake which by default is adapted to remain in the apply position until air pressure in the second chamber is sufficient to overcome resistance provided by a park brake spring.

10. The park brake control assembly according to claim 1, wherein at least one of the plurality of valves is responsive to air pressure in the output port of the distributor to release the park brake.

11. The park brake control assembly according to claim 1, wherein at least one of the plurality of valves is responsive to the air pressure in the brake pipe to release the park brake.

12. The park brake control assembly according to claim 1, wherein at least one of the plurality of valves is responsive to the air pressure in the output port of the assembly to maintain release of the park brake.

13. The park brake control assembly according to claim 1, wherein the second valve has two inputs which are responsive to air pressure in the output port of the distributor and the output port of the assembly, respectively.

14. The park brake control assembly according to claim 7, wherein the park brake control assembly is adapted to respond to isolation from the second chamber of the brake cylinder.

15. The park brake control assembly according to claim 14, wherein the park brake control assembly, when isolated from the second chamber is adapted to apply the park brake fully.

16. The park brake control assembly according to claim 1, wherein the park brake control assembly is adapted for connection with a park brake on an existing rail vehicle.

17. The park brake control assembly according to claim 1, wherein the park brake control assembly includes a manifold for connecting to the air piping of an existing rail vehicle.

18. The park brake control assembly according to claim 1, wherein the distributor is pneumatically controllable.

19. The park brake control assembly according to claim 1, wherein the distributor is electronically controllable.

20. (canceled)
